(19) United States
(12) Patent Application Publication
(10) Pub. No.: US 2014/0189954 A1
(43) Pub. Date: Jul. 10, 2014

(54) FREE FOLDING BED, DISPLACEMENT MEANS FOR SAME, AND METHOD FOR OPERATING SAME

(71) Applicant: Dae Hun Lee, Seongnam-si (KR)

(72) Inventor: Dae Hun Lee, Seongnam-si (KR)

(21) Appl. No.: 14/113,506

(22) PCT Filed: Jul. 23, 2012
(86) PCT No.: PCT/KR2012/005854

§ 371 Date: Nov. 4, 2013

(30) Foreign Application Priority Data
Jul. 25, 2011 (KR) 10-2011-0073557
Sep. 27, 2011 (KR) 10-2011-0097746
Jul. 18, 2012 (KR) 10-2012-0078461

(51) Int. Cl. A61G 7/015

(52) U.S. Cl. CPC A61G 7/015
USPC 5/618

(57) ABSTRACT

Disclosed is a free folding bed in which a support panel with a mattress arranged thereon includes a plurality of divided parts and which is freely foldable and unfoldable in vertical and horizontal directions, and more particularly, to a free folding bed in which a back support unit, a thigh support unit and the like of a support panel may be folded in a vertical direction in a state where the support panels were folded in a horizontal direction and which may be freely folded or unfolded in the vertical and horizontal directions and thus transformed according to a user or protector's intention, thereby significantly improve convenience.

### TECHNICAL FIELD

The present invention relates to a free folding bed in which a support panel with a mattress arranged thereon includes a plurality of divided parts and which is freely foldable and unfoldable in vertical and horizontal directions, and more particularly, to a free folding bed in which a back support unit, a thigh support unit and the like of a support panel may be folded in a vertical direction in a state where the support panels were folded in a horizontal direction and which may be freely folded or unfolded in the vertical and horizontal directions and thus transformed according to a user or protector's intention such that an automatic or manual mode is selected by a controller so as to significantly improve convenience, displacement means for the same, and a method for operating the same.

### BACKGROUND ART

A patient with an advanced disease, for example, a stroke patient or a patient with muscular disease (for example, Lou Gehrig's disease) must live on a special bed due to a physical disability for most time and must receive help from other people such as a protector. Thus, a contact area between the patient and the bed need to be periodically changed to induce ventilation and blood circulation such that a secondary disease such as bedsore does not occur, and the body angle of the patient needs to be changed even after eating or the like.

Conventionally, a variety of special beds have been proposed, but have focused on a horizontal folding structure for bending the upper body or knee of a patient.

Thus, the present inventor has proposed Korean Patent Laid-open Publication No. 10-2011-0043357 published on Apr. 27, 2011 and entitled “Folding Bed”. The folding bed divided into a plurality of parts may include an upper frame, an intermediate frame, and a lower frame. The upper frame is folded at an angle of 90 degrees or more through a first bent rod connected to a first cylinder, and the intermediate frame and the lower frame connected to the intermediate frame through a hinge portion are freely folded at a predetermined angle through a second bent rod connected to a second cylinder. Thus, the frame of the bed on which a patient with muscular disease lies may be folded to the front or rear side at a desired angle such that the buttocks, legs and the like of the patient may be automatically moved upward or downward. Furthermore, the left and right side surfaces of the frame may be freely folded at a desired angle through third and fourth cylinders installed at both sides of the bottom of the frame and third and fourth bent rods connected to the third and fourth cylinders, respectively. Thus, the side surfaces of the frame of the bed on which the patient with muscular disease may be folded to the left or right side at a desired angle such that the body of the patient is automatically overturned to the left or right side. Thus, the muscular movement of the patient with muscular disease, who cannot move the body, may be easily and automatically performed through the bed frame, in a state where the patient lies on a mattress over the bed frame installed in a room.

However, after the horizontal folding mode is performed, a vertical folding mode needs to be performed. Thus, the present inventor has recognized that there is a demand for a structure capable of performing the vertical folding mode, improving mass productivity, achieving reducing in weight, and increasing durability and stability, and has proposed the present invention.

### SUMMARY OF INVENTION

### Technical Problem

Various embodiments of the present invention are directed to a free folding bed which may be freely folded or unfolded in vertical and horizontal directions because a support panel for upper and lower bodies may be folded in a vertical direction after the support panel is folded in a horizontal direction, and may be transformed and used according to a user or protector's intention, thereby significantly improving convenience, and a method for operation the same.

Various embodiments of the present invention are directed to a free folding bed which separately lifts vertical divided parts stopped to support the weight of a user or patient in addition to lifted vertical divided parts and prevents the user or patient from falling, in order to secure the user or patient's safety when a support panel is folded in a vertical direction in a vertical folding mode, and a method for operating the same.

Various embodiments of the present invention are directed to a free folding bed which includes locking means for releasing lifted divided parts and locking stopped divided parts, when each support unit is rotated about a vertical rotating shaft in a vertical folding mode, thereby providing stability and reliability, and a method for operating the same.

Various embodiments of the present invention are directed to a free folding bed which includes crossing means for preventing collision of divided parts constituting each support unit when a vertical folding mode is performed after a support panel is folded in a horizontal direction, thereby performing vertical and horizontal folding modes, displacement means for the same, and a method for operating the same.

### Solution to Problem

According to an embodiment of the present invention, a free folding bed includes: a main frame; a support panel arranged on the main frame and including an upper body support unit and a lower body support unit, each of which includes a plurality of divided parts each having a vertical rotating shaft; and vertical displacement means for rotating each support unit about the vertical rotating shaft so as to lift or lower the support unit.

The free folding bed may further include vertical displacement means for rotating each support unit about the horizontal rotating shaft so as to lift or lower the support unit. The free folding bed may further include crossing means for preventing collision of the divided parts of each support unit, when each support unit is rotated about the horizontal rotating shaft by the horizontal displacement means and then rotated about the vertical rotating shaft by the vertical displacement means. The free folding bed may further include locking means for releasing the lifted or lowered divided parts and locking the stopped divided parts, when each support unit is rotated about the vertical rotating shaft by the vertical displacement means. The divided parts of the respective support units may be arranged on a plurality of vertical lines, and the vertical displacement means may include a common elevating body for moving the divided parts of the respective support units, arranged on the same vertical line, at a time.

The vertical rotating shaft or horizontal rotating shaft may include a deflection prevention member to maintain the horizontality of the divided parts. Each support unit may include three divided parts forming the same horizontal line, the divided parts of each support unit may be arranged on three vertical lines, the vertical displacement means may perform a first vertical folding mode to lift or lower the divided parts of each support unit, which are arranged on a first vertical line and a second vertical line, or perform a second vertical mode to lift or lower the divided parts of each support unit, which are arranged on the second vertical line and a third vertical line, and the free folding bed may further include safety lifting means for lifting the divided parts arranged on the third or first vertical line, when the first vertical folding mode or the second vertical folding mode is performed.

According to another embodiment of the present invention, displacement means for a free folding bed includes: an upper body support unit and a lower body support unit, which are arranged on a main frame and of which each includes a plurality of divided parts having a vertical rotating shaft, wherein the divided parts of the respective supports support units rotate the support units arranged on a plurality of vertical lines about the vertical rotating shafts; a common elevating body having a vertical shaft and a wing frame to move the divided parts of each support unit, arranged on the same vertical line, at a time; and an elevating member for rotating the wing frame about the vertical shaft.

According to another embodiment of the present invention, there is provided a method for operating a free folding bed which includes: a main frame; a support panel arranged on the main frame and including an upper body support unit and a lower body support unit, each of which includes a plurality of divided parts each having a vertical rotating shaft; vertical displacement means for rotating each support unit about the vertical rotating shaft so as to lift or lower the support unit; horizontal displacement means for rotating each support unit about a horizontal rotating shaft to lift or lower the support unit; and a controller configured to move the vertical displacement means and the horizontal displacement means. Each support unit includes three divided parts forming the same vertical line, and the divided parts of the support unit are arranged on three vertical lines, the vertical displacement means performs a first vertical folding mode to lift or lower the divided parts of each support unit, which are arranged on a first vertical line and a second vertical line, or performs a second vertical folding mode to lift or lower the divided parts of each support unit, which are arranged in the second vertical line and a third vertical line, according to control of the controller, and a safety lifting mode is performed to lift the divided parts arranged on the third or first vertical line, when the first vertical folding mode or the second vertical folding mode is performed.

Each support unit (P1, P2, P3, P4) may include a back support unit, a buttocks support unit, a thigh support unit and a calf support unit, of which each includes three divided parts arranged on the same vertical line, the horizontal displacement means may include a first motor (M1) for operating the back support unit (P1) and a second motor (M2) for operating the thigh support unit (P3), and the first and second motors may be operated to perform a horizontal folding mode, according to control of the controller.

Vertical displacement means for each of the first and second vertical folding modes may include a third or fourth motor (M3, M4), and even when the controller operates the first and second motors (M1, M2) for the horizontal folding mode so as to fold the support units in the horizontal direction, the third and fourth motors (M3, M4) for the vertical folding mode may be operated.

The controller may include an automatic mode for controlling three operations to perform, stop, and return a folding mode, and only the vertical folding mode may be performed in the automatic mode.

### Advantageous Effects of Invention

According to the embodiments of the present invention, since the support panel may be folded in the vertical direction after the support panel is folded in the horizontal direction, the free folding bed may be freely folded or unfolded. Since the free folding bed may be transformed and used according to a user or protector's intention, convenience may be significantly improved. Furthermore, when the support panel is folded in the vertical direction in the vertical folding mode, the vertical divided parts stopped to support the weight of a user or patient may be separately lifted in addition to the lifted vertical divided parts, thereby preventing the user or patient from falling. Therefore, the stability of the user or patient may be significantly improved. Furthermore, the free-folding bed may include the locking means for releasing the lifted or lowered divided parts and locking the stopped divided parts, when each support unit is rotated about the vertical rotating shaft in the vertical folding mode, thereby providing stability and reliability. Furthermore, the free folding bed may further include the crossing means for preventing collision of the divided parts of each support unit, when the vertical folding mode is performed after the support panel is folded in the horizontal direction, thereby providing the vertical and horizontal folding modes.

### BRIEF DESCRIPTION OF DRAWINGS

FIG. 1 is a side view of a free folding bed according to an embodiment of the present invention, which is related to a horizontal folding mode of support units.

FIG. 2 is a diagram illustrating a base of the free folding bed according to the embodiment of the present invention.

FIGS. 3 to 6 are diagrams illustrating a base of a free folding bed having a different structure from FIG. 2.

FIG. 7 is a diagram illustrating a support panel in the free folding bed according to the embodiment of the present invention.

FIG. 8 is a plan view of the free folding bed according to the embodiment of the present invention.

FIG. 9 is a side view of the free folding bed according to the embodiment of the present invention, which is related to a vertical folding mode.

FIG. 10 is a diagram related to vertical displacement means and locking means for the vertical folding mode in the free folding bed according to the embodiment of the present invention.

FIG. 11 is a diagram related to vertical displacement means and locking means for the vertical folding mode in the free folding bed according to the embodiment of the present invention.

### DESCRIPTION OF EMBODIMENTS

Hereinafter, the present invention will be described in detail with reference to the accompanying drawings.

It will be apparent to those skilled in the art that various modifications and variations can be made in the present invention, and thus aspects and embodiments will be described in detail. However, it should be understood that the present invention is not limited to specific embodiments, but covers modifications, equivalents and substitutes of this invention provided they come within the scope of the appended claims.

In each of the drawings, like reference numerals, or particularly, reference numerals having the same tens and units digits or the same tens digit, units digit, or alphabet represent members having the same or similar function. When there is no specific reference, a member represented by each reference numeral is based on such a standard.

Furthermore, in each of the drawings, the sizes or thicknesses of components are exaggerated or simplified for convenience of description. However, the scope of the present invention is not limited by the exaggeration or simplification.

Terms used in the present specification are used to describe only specific aspects or embodiments, and are not intended to limit the present invention. The terms of a singular form may include plural forms unless referred to the contrary. In the present application, the meaning of “include,” “comprise,” “including,” or “comprising,” specifies the existence of a property, a fixed number, a step, a process, an element, a component, or a combination thereof, but does not exclude the existence or addition of one or more other properties, fixed numbers, steps, processes, elements, components or combinations thereof.

All of terms including technical or scientific terms and used in the present specification have the same meanings as terms generally understood by those skilled in the art, as long as they are not defined in a different manner. Terms which are generally used and defined in a dictionary must be analyzed to have the same meanings as contextual meanings in the related art, and are not analyzed to have an ideally or excessively formal meaning, as long as the terms are not clearly defined in the present application.

In the present specification, terms such as “first” and “second” are used only to designate different components, and do not indicate the sequence in which the components are manufactured. The components may have different names in Description of Embodiment and the claims.

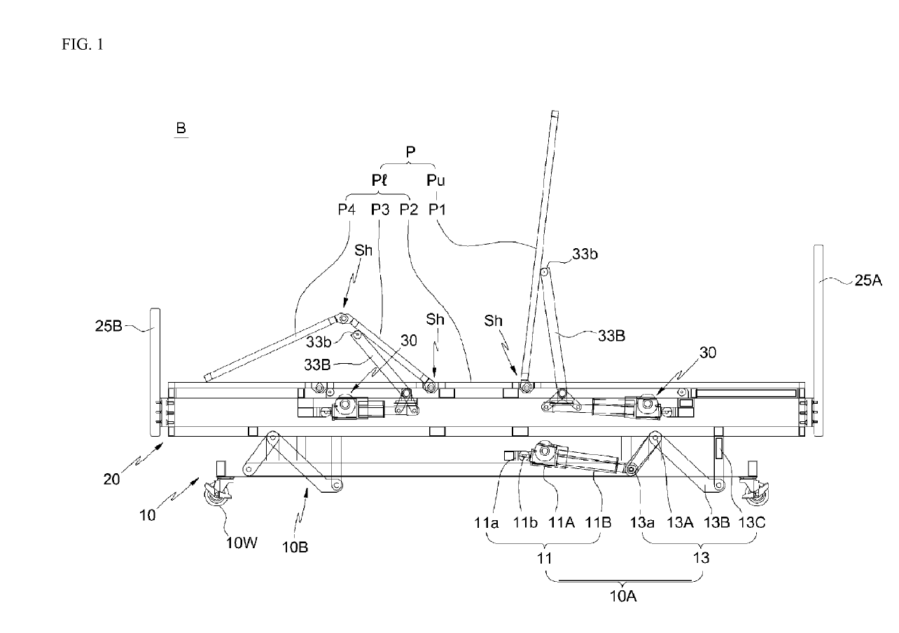

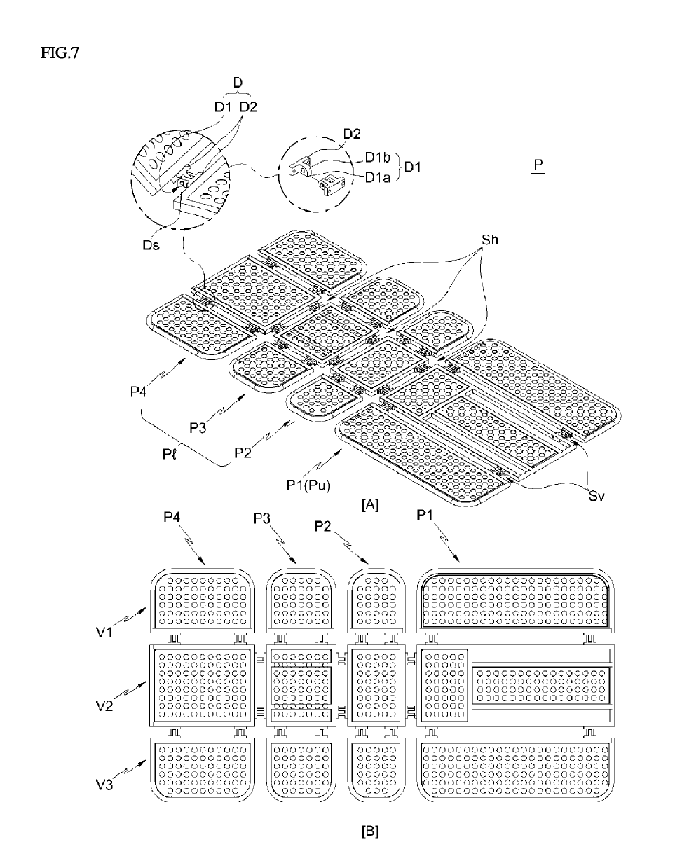

When a free folding bed B according to an embodiment of the present invention is described, directions may be approximately specified on the basis of FIGS. 1 and 7, for convenience of description. The drawings may be divided into the right and left and top and bottom sides. When descriptions are made on the basis of the other drawings, the directions may be specified according to the same standard. However, when a vertical folding mode of a support panel P and a common elevating body 45 is described, the left and right sides are distinguished from each other in a state where a back support unit P1 is located in the upper side from a protector's position. From a patient's position, the left and right sides are changed.

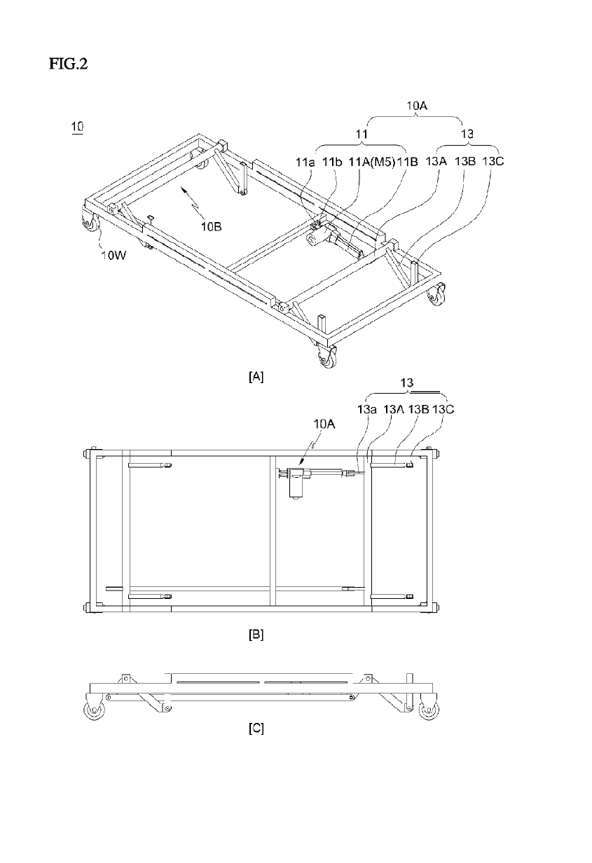

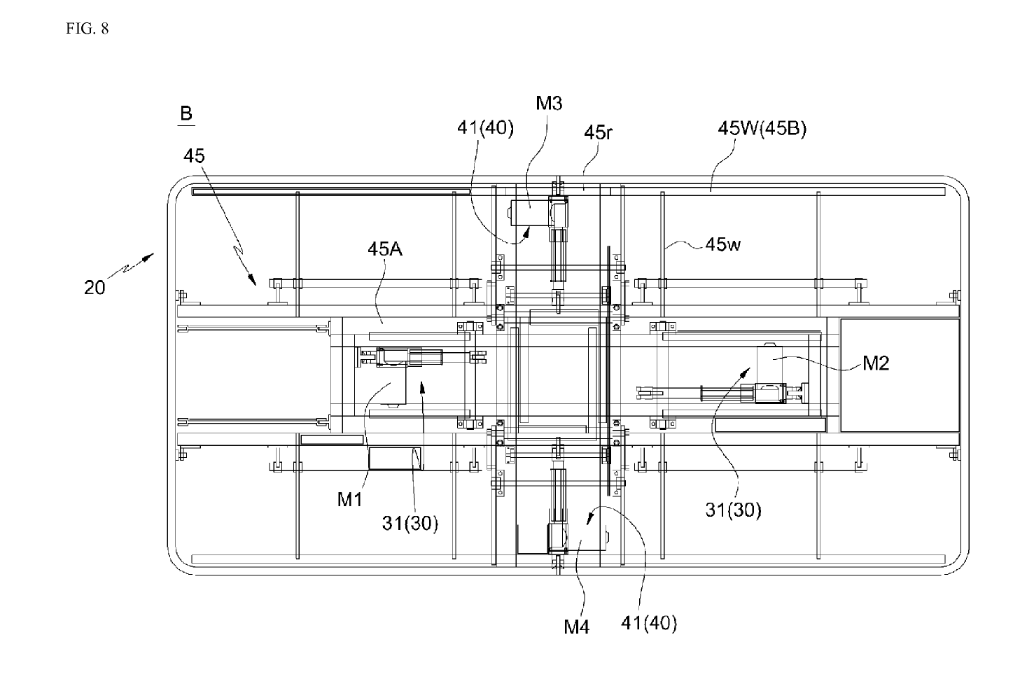

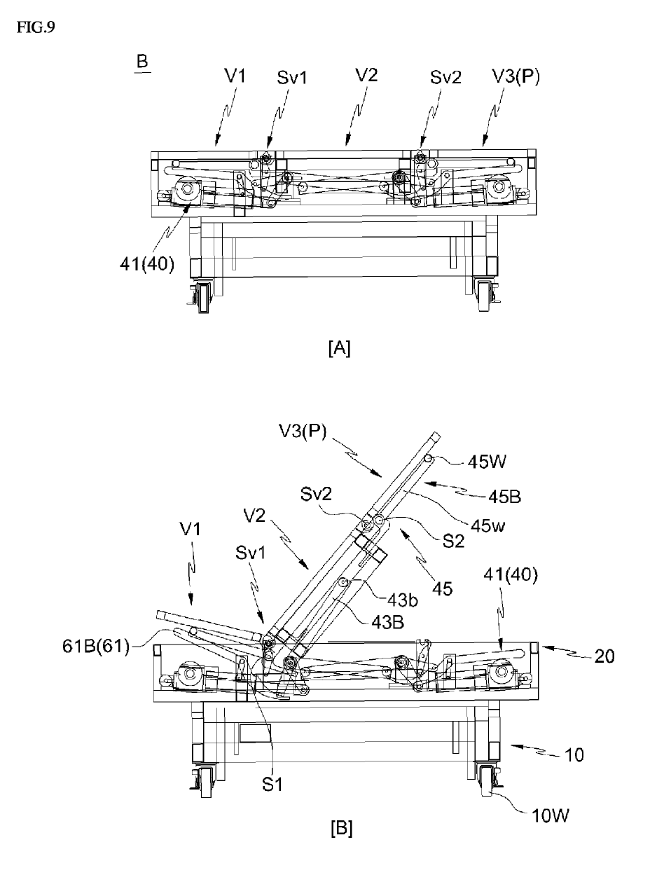

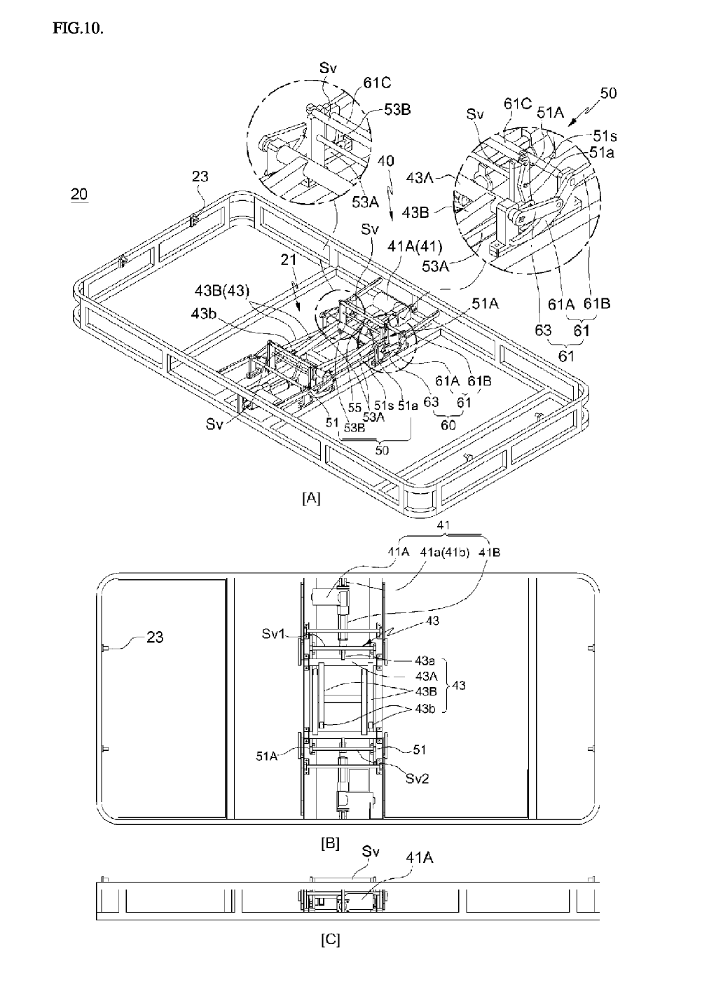

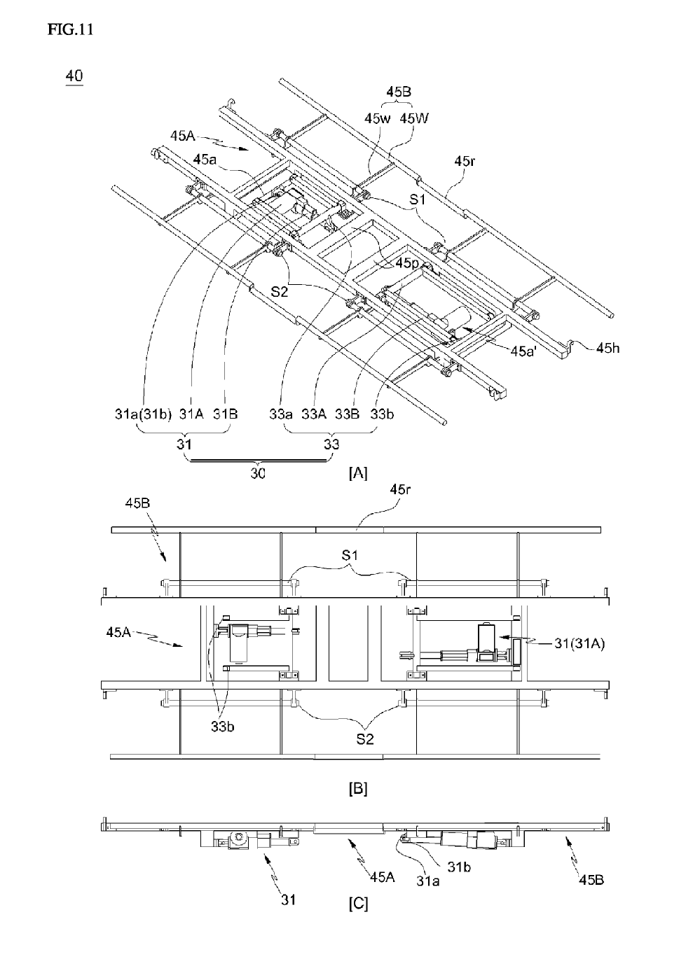

As seen from FIG. 1 which is an assembled side view of the free folding bed B, FIG. 2 which is related to a base 10, FIG. 7 which is related to a support panel P, FIG. 8 which is a plan view of the free folding bed B, FIG. 9 which is related to a vertical folding mode, FIG. 10 which is related to a main frame 20 and vertical displacement means, and FIG. 11 which is related to a common elevating body and horizontal displacement means, the free folding bed B according to the embodiment of the present invention includes a main frame 20, a support panel P including a set of support units each having multiple divided parts, horizontal displacement means for a horizontal folding mode, and vertical displacement means for a vertical folding mode.

Referring to FIGS. 1, 8, 9 and 10, the main frame 20 serving as a support frame may be utilized as it is, but the separate base 10 may be employed to secure mobility and means for lifting and lowering a mattress may be introduced. The main frame 20 may include safety fences 25A and 25B provided at the head and tail thereof, respectively. In the present invention, or particularly, the claims, ‘main frame’ is not limited to the main frame related to the shape illustrated in the drawings, but may indicate ‘any support means’ for each displacement unit or support panel.

Referring to FIGS. 1, 2, and 9, the base 10 includes four wheels, or particularly, caster-type wheels 10W provided at the bottom thereof.

Main elevating means 10A for lifting or lowering the main frame 20 in which the support panel P having a mattress (not illustrated) arranged thereon is positioned includes driving means, that is, a motor assembly 11 and an elevating body 13.

The motor assembly 11 constituting the driving means includes a motor 11, a support portion 11a at the base 10 in which a support shaft 11b for motion and support function of the motor is arranged, and a cylinder 11B including a plunger to be advanced or retreated according to the operation of the motor. The motor assembly 11 is a kind of actuator, and may be replaced with a variety of actuators which may be commercially purchased. According to the operation of the motor, a screw mounted in the cylinder is rotated to advance or retreat the plunger having a corresponding screw.

The displacement means including the motor-type driving means having the cylinder provided therein may be employed in both of the horizontal displacement means for a horizontal folding mode and the vertical displacement means for a vertical folding mode. This is an example in which a product qualified for silence and power is employed. Since the displacement means may be implemented with various electric motors and power transmission gear units or a hydraulic or pneumatic unit, the vertical displacement means and the horizontal displacement means may be implemented in various manners, and are not limited to the drawings and descriptions based on the drawings.

The elevating body 13 includes a pressurizing portion 13a connected to an end of the plunger of the cylinder 11b so as to receive a force, a rotating portion 13A, and an lifting portion 13B. The elevating body 13 has a crank-type structure, and a connection body 13C pressurizes the bottom of the main frame 20 so as to lift the main frame 20.

Interlocking elevating means 10B having no driving means is provided at the other side of the main elevating means 10A having the motor assembly 11 provided therein. The connection elevating means 10B has the same crank-type structure as the elevating body 13, except for the motor assembly.

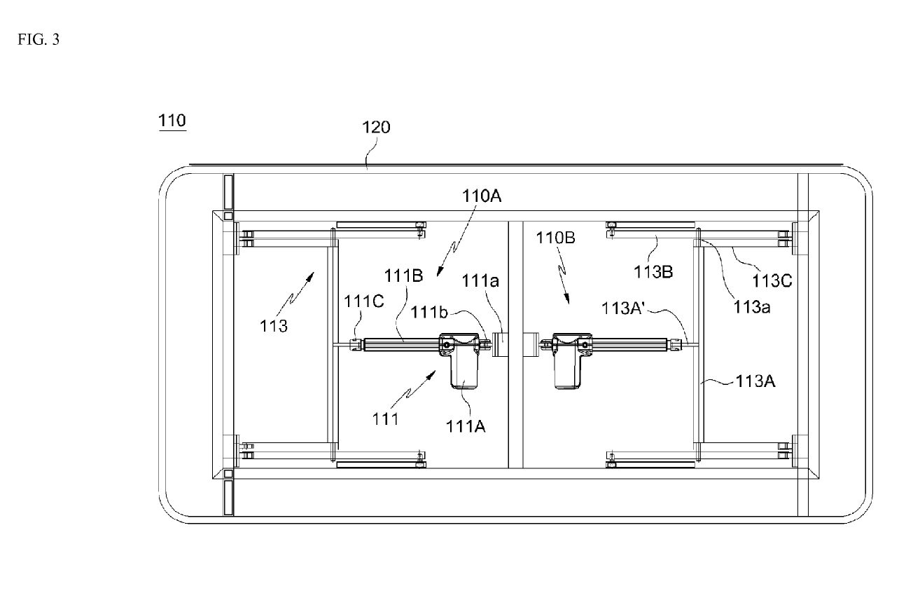

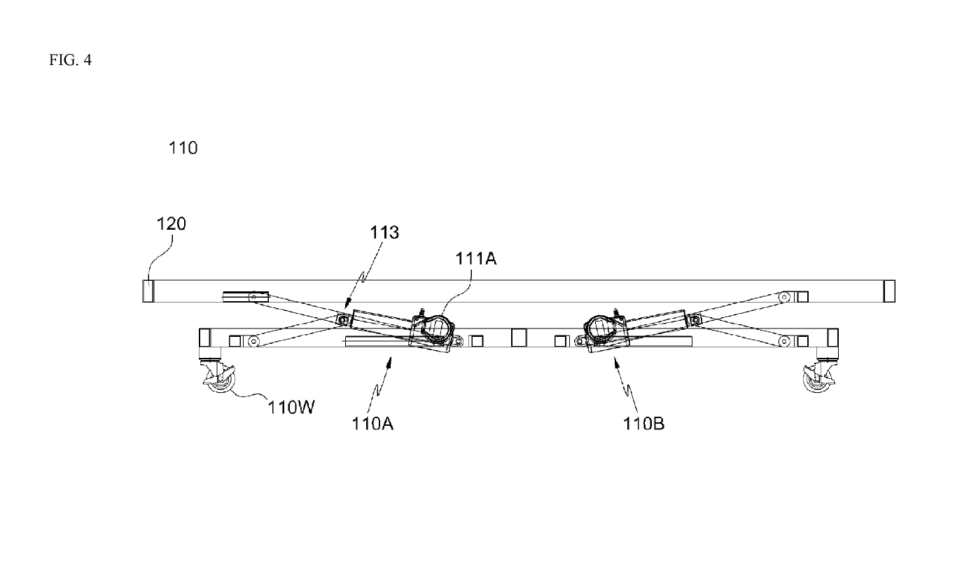

FIGS. 3 to 6 illustrate a base of a bed having a different structure from FIG. 2. The structure of FIG. 2 may be referred to as a column-type driving structure in consideration of the shape of the elevating body 13 to move the main frame 20, or, the shape of the connection body 13C, and the structure of FIGS. 3 to 6 may be referred to as a swing linker-type driving structure using a plurality of linkers.

Compared to the structure of FIG. 2, the main elevating means 110A and 110B of FIGS. 3 to 6 include a motor assembly 111 provided in both sides of a base 110. Thus, the main elevating means 110A and 110B not only may lift or lower the entire main frame 20 in a state where the main frame 20 maintains level, but also may lift or lower only the upper body or lower body of the main frame 20, regardless of a support panel.

The base 110 includes four wheels, or particularly, four caster-type wheels 110W provided at the bottom thereof, and each of the motor assemblies 111 may be implemented with an actuator. The motor assembly 111 includes a support portion 111a and a support shaft 111b which are provided at both sides of a central rod provided across the center of the base 110. Thus, the motor assembly 111 may exhibit a force while the angle of the motor 111A is changed according to movement of an elevating body 113.

A cylinder 111B having a plunger 111C is provided at the other side of the support portion 111a of the motor 111A, and the plunger 111C has an end connected to a relay linker 113A of the elevating body 113.

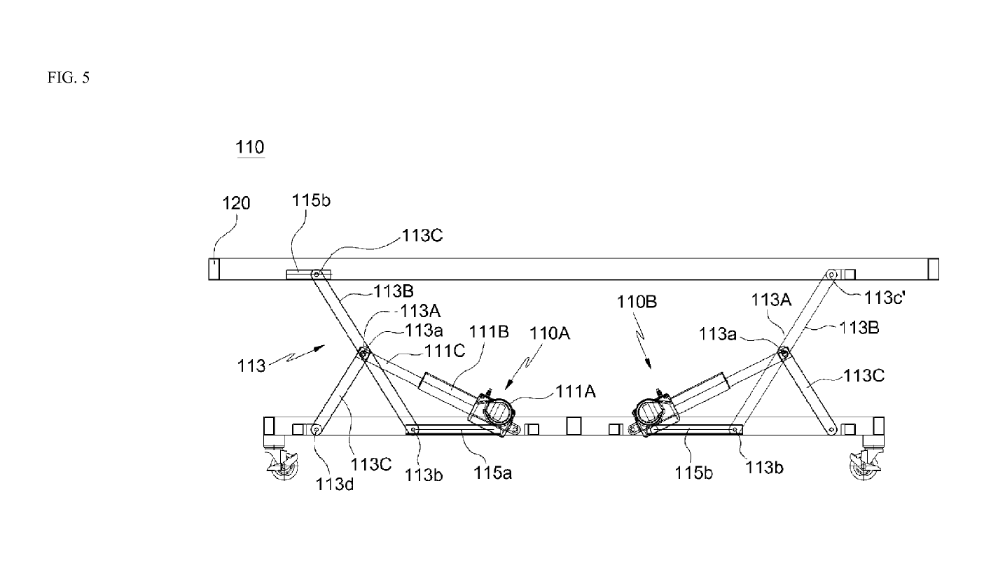

An assembly in which a main linker 113B having a relatively large length and a sub linker 113C having a relatively small length are coupled to each other is provided at both sides of the relay linker 113A of the elevating body 113 (see FIGS. 3 and 5).

Referring to FIGS. 3 and 5, the main linker 113B and the sub linker 113C of the assembly are connected to each other through a first swing shaft 113a provided in the middle of the main linker 113B, the bottom of the main linker 113B is connected to a second swing shaft 113b which is slidably provided on the base 110, or particularly, a first guide 115a, and the top of the main linker 113B is connected to the base 110 through a third switching shaft 113c. The third switching shaft 113c of the main elevating means 110A positioned in the left side of the drawings is slidably assembled to the second guide 115b of the main frame 120, and the third swing shaft 113c′ of the main elevating means 110b positioned in the right side of the drawings is rotatably connected to the main frame 120. Thus, as the main frame 20 is lifted or lowered, the main frame 120 may stably and precisely perform the operation.

In FIG. 5, the bottom of the sub linker 113C is connected to the base 10 through a fourth swing shaft 113d.

In the main elevating means 110A and 110B having such a structure, the motor 111A is operated to lift or lower the main frame 120, according to a control signal of a controller connected in a wired or wireless manner.

More specifically, as illustrated in FIGS. 3, 4 and 5, the two motors 111A of the main elevating means 110A and 110B are simultaneously driven to protrude the plungers 111C. Then, when the motor 111A rotates about the support shaft 111B and the plunger pushes a bracket-type pressurizing portion 113A′ in the center of the relay linker 113A, the relay linker 113A is rotated according to the principle of the lever. Thus, the main linker 113B is moved in an upright direction while the second swing shaft 113b at the bottom of the main linker 113B is moved along the first guide 115a, and the sub-linker 113C of which both ends are connected to the first and fourth swing shafts 113a and 113d is also moved in an upright direction while assisting the main linker 113B. Then, the main frame 120 is moved upward while maintaining level.

The third swing shaft 113c at the top of the main linker 113B of the main elevating means 110A positioned in the left side of the drawings is moved in the upward and downward directions along the second guide 115b, thereby guaranteeing a stable motion of the main elevating means 110A and 110B without damage.

When the main frame 120 is lowered, the above-described operations may be performed in an inverse order.

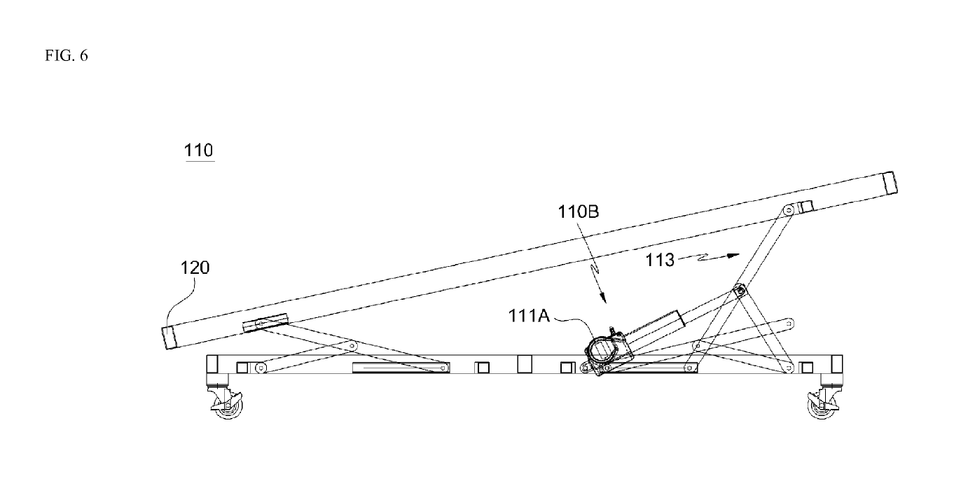

As seen from FIGS. 3, 4 and 6, only one main elevating means, for example, only the main elevating means 110B positioned in the right side of the drawings may be moved. In FIG. 6, the left motor assembly is not illustrated for convenience of description.

When only one main elevating means is moved, the rotation angle may be limited to such a level that a patient does not fall or does not receive stress. The rotation angle may be set in the range of 10 to 15 degrees.

Furthermore, after the main frame is lifted in a state where the main frame maintains level, only one main elevating means may be moved. Furthermore, the main frame may be lifted in a state where the main frame is inclined.

Referring to FIGS. 1 and 7, the support panel P includes an upper body support unit Pu and a lower body support units P1, each of which includes a plurality of divided parts having vertical and horizontal rotating shafts Sv and Sh. More specifically, the upper body support unit Pu has a support unit P1, and the lower body support unit P1 has a buttocks support unit P2, a thigh support unit P3, and a calf support unit P4. The number of support units for supporting the body parts may be increased or decreased according to the purpose.

The divided parts of the respective support units may be arranged on a plurality of vertical lines so as to guarantee the vertical folding mode as well as the horizontal folding mode.

In the drawings, each of the support units P1, P2, P3 and P4 includes three divided parts forming the same horizontal line, in consideration of operation reliability, mass productivity, price competitiveness, and durability. The divided parts of the respective support units are arranged on the three vertical lines V1, V2 and V3.

As illustrated in a dashed dotted-line circle of FIG. 7, each of the vertical and horizontal rotating shafts Sv and Sh may include a deflection prevention member D which supports each of the divided parts to maintain level.

In order to employ a simpler structure, the deflection prevention member D is implemented with a hinge member. That is, the deflection prevention member D includes a W-shaped member and a T-shaped member, and one or two brackets D1 are formed on a support portion D2 of the W-shaped member or the T-shaped member. Each of the two brackets D1 connected to a shift pin Ds includes a vertical portion D1a and a round portion D1b. Thus, the support panel may be folded in the upward direction, but cannot be formed in the downward direction, because the vertical portion D1a is contacted with the support portion D2.

The divided parts of each support unit have a plurality of holes formed therein, in order to secure ventilation and reduction in weight. The size, number, and material of the divided parts may be changed in various manners depending on the body type of a user lying on the bed. The support target areas of the support units P1, P2, P3 and P4 may be added or omitted according to the conditions of neck, head, and ankles as well as back, buttocks, thighs, and calves of the user.

The displacement means for the free folding bed according to the embodiment of the present invention, or particularly, the horizontal displacement means 30 for the horizontal folding mode rotates the support units about the horizontal rotating shafts so as to lift or lower the support units. As seen from FIGS. 1 and 11, the back support unit P1 of the upper body support unit Pu and the thigh support unit P3 of the lower body support unit P1 may be moved to bend the upper body and knee of a patient.

The horizontal displacement means 30 includes a motor assembly body 31 and an elevating body 33 which form driving means. The motor assembly 31 includes a motor 31, a support portion 31a at a support 45a of a common elevating body constituting a support structure in which a support shafts 31b for a motion and support function of the motor is arranged, or particularly, the vertical displacement means, and a cylinder 31B having a plunger to be advanced or retreated according to the operation of the motor. The elevating body 33 includes a pressurizing portion 33a, a rotating portion 33A, and a lifting portion 33B, and has a crank-type structure.

While the bottom surfaces of the back support unit P1 and the thigh support unit P3 are pressurized by a roller 33b provided at the lifting portion 33B of the elevating body 33, the respective panel units P1 and P3 are lifted. As the thigh support unit P3 is lifted, the thigh support unit P4 is rotated about the corresponding horizontal rotating shaft Sh, thereby providing a folding structure.

The displacement means for the free folding bed according to the embodiment of the present invention, or particularly, the vertical displacement means 40 for the vertical folding mode rotates a support unit about a vertical rotating shaft so as to lift or lower the support unit. As seen from FIGS. 9 and 10, the vertical displacement means provides a structure to rotate the vertical rotating shaft Sv1 between the first and second vertical lines V1 and V2 or the vertical rotating shaft Sv2 between the third and second vertical lines V3 and V2, thereby improving convenience.

The vertical displacement means includes a motor assembly 41 and an elevating body 43. The motor assembly 41 serving as driving means includes a motor 41, a support portion 41a provided on a support structure in which a support shafts 41b for motion and support function of the motor is arranged, or particularly, an outer frame of a central installation portion 21 of the main frame, and a cylinder 41B having a plunger to be advanced or retreated according to the operation of the motor. The elevating body 43 includes a pressurizing portion 43a connected to an end of the plunger of the cylinder 41b so as to receive a force, a rotating portion 43A, and a lifting portion 43B, and has a crank-type structure.

As the bottom surface of a center frame 45A of a common elevating body 45 illustrated in FIG. 11 is pressurized by a roller 43b provided at an end of the lifting portion 43b of the elevating body 43, the first or third vertical line V1 or V3 is fixed, and the support units arranged on the other two vertical lines are lifted to realize the vertical folding mode.

When the divided parts of the respective support units P1, P2, P3 and P4 of the support panel P are arranged in the plurality of vertical lines, or particularly, when the divided parts of the respective support units are arranged in the three vertical lines V1, V2 and V3 (see FIG. 7), the common elevating body 45 of the vertical displacement unit 40 moves the divided parts of each support unit, arranged on the same vertical line, at a time.

Referring to FIG. 7, the common elevating body has a structure of lifting all of the divided parts arranged on one vertical line at a time. In the present specification and the claims, ‘common elevating body’ to move the divided parts ‘at a time’ indicates means for lifting or lowering the divided parts which are arranged on the same vertical line but belong to two or more different support units, at a time (regardless of whether or not the supports units are adjacent to each other).

More specifically, as illustrated in FIG. 11, the common elevating body 45 includes a vertical shaft and a wing frame 45B. The common elevating body includes the motor assembly 31 and the elevating body 33 constituting the horizontal displacement means 30 such that the vertical folding mode is performed after the horizontal displacement unit 30 lifts the upper body support unit Pu or the lower body support unit P1, or particularly, the back support unit P1 or the thigh support unit P3 so as to perform the horizontal folding mode. For this operation, the common elevating body 45 includes a support 45a arranged in an installation portion 45a′ of the center frame 45A disposed in the center thereof and supporting the support shaft 31 of the motor 31A of the motor assembly 31.

Referring to FIGS. 9, 10 and 11, the vertical displacement means 40 lifts or lowers the divided parts of the respective support units arranged on the first and second vertical lines V1 and V2 so as to perform a first vertical folding mode, or lifts or lowers the divided parts of the respective support units arranged on the second and third vertical lines V2 and V3 so as to perform a second vertical folding mode (see FIG. 9B).

More specifically, when the motor 41A connected to the support portion 41a and the support shaft 41b through a central vertical bar (not indicated) for connecting the upper and lower rectangular outer frames of the installation portion 21, that is, the main frame 20 is operated in the motor assembly forming the driving means, the plunger protrudes through the operation of the cylinder 31B.

Thus, as the pressurizing portion 43a of the elevating body 43 connected to the plunger is pushed and the rotating portion 43A is rotated, the lifting portion 43B in the opposite side of the pressurizing portion is lifted. Furthermore, the roller 43b provided at an end of the lifting portion pressurizes the bottom surface of a horizontal pressurized portion 45P in the center of the center frame 45A of the common elevating body 45 and lifts the pressurized portion 45p as illustrated in FIG. 9B. Then, the divided parts of the support units arranged on the second and third vertical lines V2 and V3 are lifted.

More specifically, the divided parts of the support units arranged on the first vertical line V1 are fixed, the vertical rotating shafts Sv1 of the divided parts of on first and second vertical lines V1 and V2 are folded, the left wing frame 45B of the wing frames 45B provided at both sides of the center frame 45A of the common elevating body 45 stays put and is folded around the first rotating shaft S1, and the center frame 45A and the right wing frame 45B are lifted in a state where the center frame 45A and the right wing frame 45B form a straight line. Since the center frame 45A and the right wing frame 45B are fixed, the angle of the second vertical shaft S2 is not changed.

Thus, the divided parts of the support units arranged on the second and third vertical lines V2 and V3 are lifted.

Referring to FIG. 10B, two sets of motor assemblies 41 and elevating bodies 43 are provided as the driving means of the vertical displacement means, and the lifting portion 43B of each of the elevating bodies 43 includes a pair of bar-type members, and the pair of bar-type members of the lifting portion 43B are arranged adjacent to cross each other.

During the vertical folding mode, a patient having a physical disability may fall in the opposite side when only the support units arranged on the plurality of vertical lines are lifted.

Thus, safety lifting means may be provided to separately lift the vertical divided parts stopped to support the weight of a user or patient in addition to the lifted vertical divided parts, thereby preventing the user or patient from falling.

As illustrated in FIG. 7, when the support units are arranged on the first, second, and third vertical lines V1, V2 and V3, the safety lifting means 60 lifts the divided parts arranged on the third or first vertical line during the first vertical folding mode or the second vertical folding mode.

Specifically, the safety lifting means 60 is interlocked to the other displacement means, or particularly, the motor assembly 41 and the elevating body 43 of the vertical displacement means 40, in order to simplify the structure.

As illustrated in FIG. 10A and dashed dotted-line circles positioned at the top side of FIG. 10A, the safety lifting means 60 includes a pressing member 63 and a seesaw bar 61.

That is, when the rotating portion 43A of the elevating body 43 is rotated by the operation of the motor 41A, the pressing member 63 coaxially arranged on the outside of a shaft support pillar at both sides of the rotating portion 43A is rotated downward to press a lowering portion 61A, and a lifting portion 61B outside the frame 20 is lifted around a seesaw shaft 61C.

Thus, referring to FIG. 9B, as the lifting portion 43B of the elevating body 43 is lifted, the center frame 45A and the right wing frame 45B of the common elevating body 45 are lifted, and a sidebar 45W of the left wing frame 45B is lifted by the left lifting portion 61B of the seesaw bar 61 of the safety lifting means 60, and moved slightly upward on the basis of the first vertical line S1, thereby stably supporting the right body part of the patient.

The safety lifting means realizes a safety lifting mode in the relation with a method for operating the free folding bed according to the embodiment of the present invention, according to control of the controller.

The free folding bed B and the displacement means for the same, or particularly, the vertical displacement means 40 for the vertical folding mode may include separate locking means to improve stability and durability.

The locking means releases the lifted or lowered divided parts and locks the stopped divided parts, when the respective support units are rotated about the vertical rotating shafts Sv by the vertical displacement means.

That is, as illustrated in FIG. 10 and the dashed dotted-line circles positioned in the top side of FIG. 10A, the locking means 50 includes lockers 51 and 51A, links 53A and 53B, and an interlocking member 55.

When the seesaw bar 61 of the safety lifting means 60 is moved, the seesaw shaft 61C having two seesaw bars 61 provided at both sides thereof according to the position and number of the pressing members 63 provided at both sides of the rotating portion 43A in the elevating body 43 of the vertical displacement means 40 is rotated to pull the second link 53B provided at the bottom of one side of the seesaw shaft 61C to the outside of the main frame 20. Then, as the first link 53A connected to the second link is moved, the connection-type locker 51A having a connection piece 51a provided at the bottom of a shaft 51s is moved. When the connection member 55 connecting the two lockers 51 and 51A is rotated to move the other non-connection type locker 51, the hook portion escapes from both ends of the vertical rotating shaft Sv. Thus, referring to FIGS. 10B and 9, since the second vertical rotating shaft Sv2 which is lifted between the two vertical rotating shafts Sv is unlocked, the divided parts on the second and third vertical lines V2 and V3 are released.

In the drawings, one first link 53A and one second link 53B are provided at a position leaning to one side, for each vertical displacement means 40.

Furthermore, as illustrated in FIG. 11, four hooks 45h are provided at both ends of the common elevating body 45, or particularly, at both sides of the center frame 45a, and a catcher pin 23 is provided at a corresponding position of the main frame 20 so as to improve the safety function. Thus, when the weight of a patient is applied to the divided parts of the support units on any one vertical line, which are not lifted, in the vertical folding mode, the vertical rotating shafts Sv may be lifted to prevent the patient from coming off and falling from the bed B.

When the lifted support panel divided parts on the vertical lines V2 and V3 are intended to be lowered, the motor 41A of the motor assembly 41 of the vertical displacement means 40 is reversely rotated, the cylinder 41B is also inversely moved, the respective components 43A, 43a, and 43B of the elevating body 43 are inversely moved, the right wing frame 45B and the right side of the center frame 45A are lowered, and the pressing member 63 having pressed the lowering portion 61A of the seesaw bar 61 of the safety lifting means 60 is lifted. Thus, since the pressing force is released to lower the lifting portion 61B, the left wing frame 45B and the divided parts of the support panel P on the vertical line V1, which have been slightly lifted for safety, are moved downward.

Furthermore, as the seesaw shaft 61C is rotated in the opposite direction, the first and second links 53A and 53B are connected, and the hook portion is engaged with the end of the vertical rotating shaft Sv around the shaft 51s of the connection piece 51a of the connection-type locker 51A. Two right hooks of two pairs of hooks 45h at both ends of the center frame 45a are caught in the catcher pin 23 arranged at a corresponding position of the main frame 20.

The free folding bed B and the displacement means for the same, or particularly, the vertical displacement means 40 for the vertical folding mode include the crossing means. Thus, when the respective support units are rotated about the horizontal rotating shafts by the horizontal displacement means and then rotated about the vertical rotating shafts by the vertical displacement means, the crossing means may prevent collision between the divided parts of the respective support units.

The crossing means may be implemented with driving means for separately moving the divided parts of the respective support units. However, in order to simplify the structure, the crossing means may be included in the common elevating body 45.

That is, referring to FIG. 11, a recess bar 45r is formed in the center of a side bar 45W connected through the first and second vertical shafts S1 and S2 and the link bar 45w in the wing frame 45B connected through the first and second vertical shafts S1 and S2 at both sides of the center frame 45S. The recess bar 45r functions as the crossing means.

That is, the respective divided parts of the support panel P in the assembled bed B form a flat plane in a state in which the vertical folding mode is not performed. The outsides of the divided parts on the first and second vertical lines V1 and V2 are supported by the outside of the main frame 20.

However, when any one wing frame 45B is lifted for the vertical folding mode, the outsides of the divided parts on the first and third vertical lines V1 and V3 escape from the main frame 20. At this time, the divided parts of the support panel outside the buttocks support unit P2 (on the first or third vertical line) are positioned on the recess bar 45r forming the crossing means. Thus, since the divided parts deviate from the other divided parts, the divided parts are not positioned on the same plane.

Furthermore, the divided part in the opposite side which are not lifted by the vertical displacement unit 40 through the safety lifting means 60, that is, the divided part positioned at the edge of the buttocks support unit P2 (on the third or first vertical line) is also positioned on the recess bar 45r forming the crossing means, and thus deviates from the other divided parts.

In this state, although the horizontal displacement means 30 is moved and the back or thigh support unit P1 or P3 is moved to perform the horizontal folding mode, the back or thigh support unit P1 or P3 does not collide with the divided parts at the edges of the buttocks support unit P2 positioned on the recess bars 45r of both of the wing frames 45B. Thus, the vertical folding mode and the horizontal folding mode may be smoothly performed.

In each of the drawings, the lifting and lowering of the free folding bed B according to the embodiment of the present invention, or particularly, the displacement modes related to the horizontal displacement means and the vertical displacement means may be performed through a wired or wireless controller in an automatic or manual mode.

The controller may include an operation control button, a stop control button, and a return control button for each motor, a manual mode or automatic mode select button, a dial-type control terminal or joystick-type control terminal, a display, and a speaker for voice guide. The control buttons may be implemented with one switch in which the respective functions are combined. The controller may be configured in a touch-screen type, if necessary.

First, referring to FIGS. 8 and 2, the operation of the manual mode will be described as follows. The manual mode is only an embodiment for preventing a malfunction, error, and side effect.

1) When any one motor 31A of the motor assembly 31 constituting the horizontal displacement means 30 which rotates with the common elevating body 45, or particularly, the center frame 45A, that is, any one of first and second motors M1 and M2 in FIG. 8 is operated, any one motor 41A of the motor assembly 41 constituting the vertical displacement means 40, that is, any one of third and fourth motors M3 and M4 in FIG. 8 is not operated.

2) Even when the first and second motors M1 and M2 for the horizontal folding mode are moved to fold the support units in the horizontal direction, the third and fourth motors M3 and M4 for the vertical folding mode may be moved.

3) When the third or fourth motor M3 or M4 for the vertical folding mode is moved, the other motor M4 or M3 is not operated.

4) The motor 11A of the motor assembly 11 constituting the main elevating means 10A, for example, the fifth motor M5 in FIG. 2 may operate regardless of the first to fourth motors M1 to M4.

The fifth motor M5 is a motor for lifting and lowering the main frame 20 like the main elevating means 10A and the interlocking elevating means 10B of FIGS. 1 and 2, and may be configured to lift and lower the main frame 20 in a state where the main frame 20 maintains level. Alternatively, the fifth motor M5 may include a motor constituting the main elevating means 10A configured to lift only the head of a user as illustrated in FIG. 6, or a motor configured to provide a tilting function of the main fame 20 through separate motors provided at the head and feet of the user like the main elevating means 110A and 110B of FIG. 5.

Referring to FIG. 5, when two fifth motors M5 are provided to life the upper body and the lower body, respectively, the fifth motors M5 and M6 must be operated in synchronization with each other in case where the motors are operated at the same time.

5) The first and second motors M1 and M2 for the horizontal folding mode may be moved at the same time.

Furthermore, when two or more motors 11A for the main elevating means 10A for lifting and lowering the main frame 20 are provided, the fifth motors M5 may be moved at the same time.

6) In the automatic mode, the first, second, and fifth motors M1, M2 and M5 may be configured so as not to be operated, in order to improve the safety. That is, only the vertical folding mode may be performed.

7) Vertical and horizontal tilting angles preferred by a user may be memorized.

Next, the operation of the automatic mode will be described as follows. The automatic mode is only an example for preventing a malfunction, an error, and a side effect.

1) The automatic or manual mode may be selected.

2) The third and fourth motors M3 and M4 may be set to have the following configurations:
operation time setup range: 0 to 120 minutes (The time during which the vertical folding mode is maintained and a standby time in an unfolded state is may be separately set up. At this time, an operation time for folding or unfolding is not calculated but ignored.)
the minimum unit of the time setup is five minutes, and five minutes are increased/decreased whenever a control button is pressed
five minutes are increased/decreased at every 0.5 second, while the button is continuously pressed
operation angle setup range: 0 to 40 degrees
the minimum unit of the angle setup is five degrees, and five to ten degrees are increased/decreased whenever a control button is pressed
the minimum unit of angle and time may be changed when parameters are set up.

3) Mode selection function
mode 1: the third motor M3 is independently operated
mode 2: the fourth motor M4 is independently operated
mode 3: the third and fourth motors M3 and M4 are operated in connection with each other.

4) When the mode is switched from the manual mode to the automatic mode or switched from the automatic mode to the manual mode, all of the motors return to the original positions, and the next operation is then performed.

5) At the position of “setting change”, the settings of the automatic mode may be checked and initialized or reset.

6) The settings of the automatic mode may be memorized according to three or more different operation orders.

7) A display through which the settings are checked may be provided.

In addition, common requirements in the manual or automatic mode will be described as follows.

1) When an error occurs during operation, all of the modes must be stopped.

2) An emergency stop switch may be provided to stop the operation during an emergency.

3) A switch for turning on/off power may be provided.

4) When a button is manipulated, an operation check sound (about 10db) may be provided, or a lamp may be lit or flickered at the same time.

5) The first to fifth motors may have a deceleration function and a smooth stop function, when the main frame is lowered.

However, the deceleration function may be performed at a position corresponding to 80% of the maximum lifting angle, in order to quickly drive the motors. At this time, the motors are decelerated at a speed of ½.

6) The maximum lifting angle of each angle adjusting part may be inputted to a control board through a personal computer when the bed is shipped or repaired. In the interlock relation among the first to fourth motors, “use” or “no use” may be selected when parameters are set up.

The operation specifications of each mode will be described as follows.

1) The first motor M1 for the back support unit P1

The maximum lifting angle of the back support unit P1 is 85 degrees, and the stroke of the first motor is 100 mm.

2) The second motor M2

The maximum lifting angle of the second motor M2 for the thigh support unit P3 is 40±2.5 degrees, and the stroke of the second motor is 50 mm.

3) The third motor M3

The maximum lifting angle of the third motor M3 for lifting the divided parts of the support panels P arranged on the second and third vertical lines V2 and V3 (hereinafter, referred to as ‘right plate’) is 50±2.5 degrees, and the stroke of the motor is 90 mm. The third motor M3 operates in an idle state at a section of 0 to 18 mm, and lifts the left plate at a section of 18 to 90 mm.

4) The fourth motor M4

The maximum lifting angle of the fourth motor M4 for lifting the divided parts of the support panel P arranged on the first and second vertical lines V1 and V2 (hereinafter, referred to as ‘left plate’) is 50 degrees, and the stroke of the motor is 90 mm. The fourth motor operates in an idle state at a section of 0 to 18 mm, and lifts the left plate at a section of 18 to 90 mm.

5) The fifth motor M5

The fifth motor M5 for lifting and lowering the main frame 20 may be configured to lift or lift the main frame 20 in a state where the main frame 20 maintains level (in the case of the main elevating means 10A and the interlock elevating means 10B of FIGS. 1 and 2), or configured to lift only the head of the user (in the case of the main elevating means 110B of FIG. 6).

Furthermore, separate motors may be employed at the head and feet of the user, in order to provide the tilting function of the main frame 20 (in the case of the main elevating means 110A and 110B of FIG. 5). At this time, a column-type actuator may be used as the motor M5.

During the tilting operation, any one of the motors provided at the head and feet of the user may be driven. When the main frame is lifted or lowered in a state where the main frame maintains level, the motors may be driven at the same time. The maximum tilting angle of the bed may be set to 12.5±0.5 degrees.

6) Others

The first, third, and fourth motors M1, M3 and M4 may have a deceleration function when the main frame is lowered. The speed may be decelerated to ½ at a point corresponding to 80% of the maximum lifting angle.

The maximum ascending angle of each motor may be arbitrarily adjusted and inputted to the controller. In the interlock relation among the first to fourth motors, parameters may set up to select “use” or “no use”, when the bed is shipped.

Although various embodiments have been described for illustrative purposes, it will be apparent to those skilled in the art that various changes and modifications may be made without departing from the spirit and scope of the invention as defined in the following claims.

1. A free folding bed comprising:
a main frame;
a support panel arranged on the main frame and comprising an upper body support unit and a lower body support unit, each of which includes a plurality of divided parts each having a vertical rotating shaft; and
vertical displacement means for rotating each support unit about the vertical rotating shaft so as to lift or lower the support unit.

2. The free folding bed of claim 1, further comprising vertical displacement means for rotating each support unit about the horizontal rotating shaft so as to lift or lower the support unit.

3. The free folding bed of claim 2, further comprising crossing means for preventing collision of the divided parts of each support unit, when each support unit is rotated about the horizontal rotating shaft by the horizontal displacement means and then rotated about the vertical rotating shaft by the vertical displacement means.

4. The free folding bed of claim 1, further comprising locking means for releasing the lifted or lowered divided parts and locking the stopped divided parts, when each support unit is rotated about the vertical rotating shaft by the vertical displacement means.

5. The free folding bed of claim 1, wherein the divided parts of the respective support units are arranged on a plurality of vertical lines, and the vertical displacement means comprise a common elevating body for moving the divided parts of the respective support units, arranged on the same vertical line, at a time.

6. The free folding bed of claim 1, wherein the vertical rotating shaft or horizontal rotating shaft comprises a deflection prevention member to maintain the horizontality of the divided parts.

7. The free folding bed of claim 1, wherein each support unit comprises three divided parts forming the same horizontal line,
the divided parts of each support unit are arranged on three vertical lines,
the vertical displacement means performs a first vertical folding mode to lift or lower the divided parts of each support unit, which are arranged on a first vertical line and a second vertical line, or performs a second vertical mode to lift or lower the divided parts of each support unit, which are arranged on the second vertical line and a third vertical line, and
the free folding bed further comprises safety lifting means for lifting the divided parts arranged on the third or first vertical line, when the first vertical folding mode or the second vertical folding mode is performed.

8. Displacement means for a free folding bed, comprising:
an upper body support unit and a lower body support unit, which are arranged on a main frame and of which each includes a plurality of divided parts having a vertical rotating shaft, wherein the divided parts of the respective supports support units rotate the support units arranged on a plurality of vertical lines about the vertical rotating shafts;
a common elevating body having a vertical shaft and a wing frame to move the divided parts of each support unit, arranged on the same vertical line, at a time; and
an elevating member for rotating the wing frame about the vertical shaft.

9. A method for operating a free folding bed which includes: a main frame; a support panel arranged on the main frame and comprising an upper body support unit and a lower body support unit, each of which includes a plurality of divided parts each having a vertical rotating shaft; vertical displacement means for rotating each support unit about the vertical rotating shaft so as to lift or lower the support unit; horizontal displacement means for rotating each support unit about a horizontal rotating shaft to lift or lower the support unit; and a controller configured to move the vertical displacement means and the horizontal displacement means,
wherein each support unit comprises three divided parts forming the same vertical line, and the divided parts of the support unit are arranged on three vertical lines,
the vertical displacement means performs a first vertical folding mode to lift or lower the divided parts of each support unit, which are arranged on a first vertical line and a second vertical line, or performs a second vertical folding mode to lift or lower the divided parts of each support unit, which are arranged in the second vertical line and a third vertical line, according to control of the controller, and
a safety lifting mode is performed to lift the divided parts arranged on the third or first vertical line, when the first vertical folding mode or the second vertical folding mode is performed.

10. The method of claim 9, wherein each support unit comprises a back support unit, a buttocks support unit, a thigh support unit and a calf support unit, of which each includes three divided parts arranged on the same vertical line,
the horizontal displacement means comprises a first motor for operating the back support unit and a second motor for operating the thigh support unit, and
the first and second motors are operated to perform a horizontal folding mode, according to control of the controller.

11. The method of claim 10, wherein vertical displacement means for each of the first and second vertical folding modes comprise a third or fourth motor, and
even when the controller operates the first and second motors for the horizontal folding mode so as to fold the support units in the horizontal direction, the third and fourth motors for the vertical folding mode are operated.

12. The method of claim 10, wherein the controller comprises an automatic mode for controlling three operations to perform, stop, and return a folding mode, and
only the vertical folding mode is performed in the automatic mode.
